(19) United States
(12) Patent Application Publication
(10) Pub. No.: US 2026/0026985 A1
(43) Pub. Date: Jan. 29, 2026

(54) FIXED BED EXTENSION ACCESSORY

(71) Applicant: Hill-Rom Services, Inc., Batesville, IN (US)

(72) Inventors: Jacques Antoine Donval, Pluvigner (FR); Anne Joly, Plumergat (FR); Thomas Roudil, Vannes (FR)

(73) Assignee: Hill-Rom Services, Inc., Batesville, IN (US)

(21) Appl. No.: 19/277,570

(22) Filed: Jul. 23, 2025

Related U.S. Application Data
(60) Provisional application No. 63/674,854, filed on Jul. 24, 2024.

(51) Int. Cl. A61G 7/002; A61G 7/10

(52) U.S. Cl. CPC A61G 7/002; A61G 7/1057

(57) ABSTRACT

An extension accessory for a patient bed includes an extension plate that has a peripheral edge defining a top surface for supporting a patient and a bottom surface with a plurality of holes extending through the top and bottom surfaces. A plurality of connection blocks each includes a top block surface spaced from a bottom block surface. An engagement profile is between the top block surface and the bottom block surface that is sized to be coupled to a moveable beam. An opening extends through the top block surface, and a plurality of fastening members are each configured to be inserted through one of the holes of the extension plate and the opening of one of the plurality of connection blocks.

### CROSS-REFERENCE TO RELATED APPLICATION

This application claims priority under U.S.C. § 119 (e) to U.S. Provisional Application No. 63/674,854 filed on Jul. 24, 2024, entitled “FIXED BED EXTENSION ACCESSORY,” the disclosure of which is hereby incorporated by reference in its entirety.

### FIELD OF THE DISCLOSURE

The present disclosure generally relates to a patient bed with an accessory, and, more particularly, a bed extension accessory that increases a patient support surface of a patient bed.

### BACKGROUND

In medical environments, patients can be confined to patient beds for extended periods of time. Patient beds are often designed with both comfort and mobility as major considerations. For example, it is often necessary to move the patient beds around the medical environment based on patient needs, scheduled procedures, room availability, and the like. The process of moving the patient beds around busy hallways and through door openings in the medical environment can be arduous. More particularly, the patient beds are cumbersome as they must be large enough to comfortably support a variety of patient sizes in both width and length.

Accordingly, the present disclosure generally relates to a bed extension accessory that increases a patient support surface of a patient bed. In this manner, the patient bed can be sized to ease mobility for a majority of patient sizes, but extendable when the patient support surface is undersized for a particular patient.

### SUMMARY OF THE DISCLOSURE

According to one aspect of the present disclosure, an extension accessory for a patient bed includes a first moveable beam and a second moveable beam both configured to be attached to the patient bed and moveable between a stowed position and an extended position. The first moveable beam defines a first longitudinal groove and includes at least one first pocket. An actuating assembly includes an actuating body extending through the first longitudinal groove between a first locking body and a lever. The actuating body is moveable between a locked position where the first locking body is located in the at least one first pocket to secure the first moveable beam from movement, and an unlocked position where the actuating body is configured to be moved by engagement with the lever and the first locking body is located outside of the at least one first pocket, permitting movement of the first moveable beam. At least one connection block includes an engagement profile that is sized to be inserted into the first longitudinal groove and prevent movement of the actuating body. An extension plate is connectable to the at least one connection block.

According to another aspect of the present disclosure, an extension accessory for a patient bed includes an extension plate that has a peripheral edge defining a top surface for supporting a patient and a bottom surface with a plurality of holes extending through the top and bottom surfaces. A plurality of connection blocks each includes a top block surface spaced from a bottom block surface. An engagement profile is between the top block surface and the bottom block surface that is sized to be coupled to a moveable beam. An opening extends through the top block surface, and a plurality of fastening members are each configured to be inserted through one of the holes of the extension plate and the opening of one of the plurality of connection blocks.

According to yet another aspect of the present disclosure, a patient bed includes a patient support surface extending between a headboard and a footboard. A pair of stationary beams is located under and coupled to the patient support surface. A pair of moveable beams is each moveably coupled to one of the pair of stationary beams and moveable between a stowed position and an extended position. The pair of moveable beams each defines a longitudinal groove and at least one pocket. An actuating assembly includes an actuating body extending through the longitudinal grooves between a pair of locking bodies spaced by a lever. The actuating body is moveable between a locked position where the locking bodies are located in the at least one pockets, to secure the pair of moveable beams from movement, and an unlocked position where the actuating body is configured to be moved by engagement of the lever and the locking bodies are located outside of the at least one pockets, permitting movement of the pair of moveable beams relative to the stationary beams. An extension plate is selectively coupled to the moveable beams.

According to still yet another aspect of the present disclosure, a connection block of an extension accessory for a patient bed includes a top block surface defining an opening for receiving a fastener. A bottom block surface is spaced from the opening. An engagement profile is located between the top block surface and the bottom block surface that includes a beam recess sized to insert an upper edge of a moveable beam.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front, left, upper perspective view of a patient bed with an extension accessory, according to an aspect of the present disclosure;

FIG. 2 is a front, left, upper perspective view of an extension accessory for a patient bed, according to an aspect of the present disclosure;

FIG. 3 is a front, left, lower perspective view of a patient bed with an extension accessory, according to an aspect of the present disclosure;

FIG. 4 is a front, left, lower perspective view of an extension accessory for a patient bed, according to an aspect of the present disclosure;

FIG. 5 is a top plan view of an extension accessory for a patient bed, according to an aspect of the present disclosure;

FIG. 6 is an enlarged front, left, lower perspective view of an extension accessory for a patient bed, according to an aspect of the present disclosure;

FIG. 7 is a cross-sectional front view of a moveable beam of an extension accessory paired with a stationary beam of a patient bed, according to an aspect of the present disclosure;

FIG. 8 is a front upper perspective view of an insert that extends between and couples a moveable beam of an extension accessory and a stationary beam of a patient bed, according to an aspect of the present disclosure;

FIG. 9 is a side perspective view of a pair of connection blocks that lock a position of a moveable beam of an extension accessory relative to a stationary beam of a patient bed, according to an aspect of the present disclosure;

FIG. 10A is a front profile view of a connection block that locks a position of a moveable beam of an extension accessory relative to a stationary beam of a patient bed, according to an aspect of the present disclosure;

FIG. 10B is a rear profile view of a connection block that locks a position of a moveable beam of an extension accessory relative to a stationary beam of a patient bed, according to an aspect of the present disclosure;

FIG. 10C is a side profile view of a connection block that locks a position of a moveable beam of an extension accessory relative to a stationary beam of a patient bed, according to an aspect of the present disclosure; and

FIG. 11 is a disassembled view of an extension accessory prior to being coupled to a patient bed, according to an aspect of the present disclosure.

### DETAILED DESCRIPTION

The present illustrated embodiments reside primarily in combinations of method steps, systems, devices, and apparatus components related to a bed extension accessory that increases a patient support surface of a patient bed. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

The specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

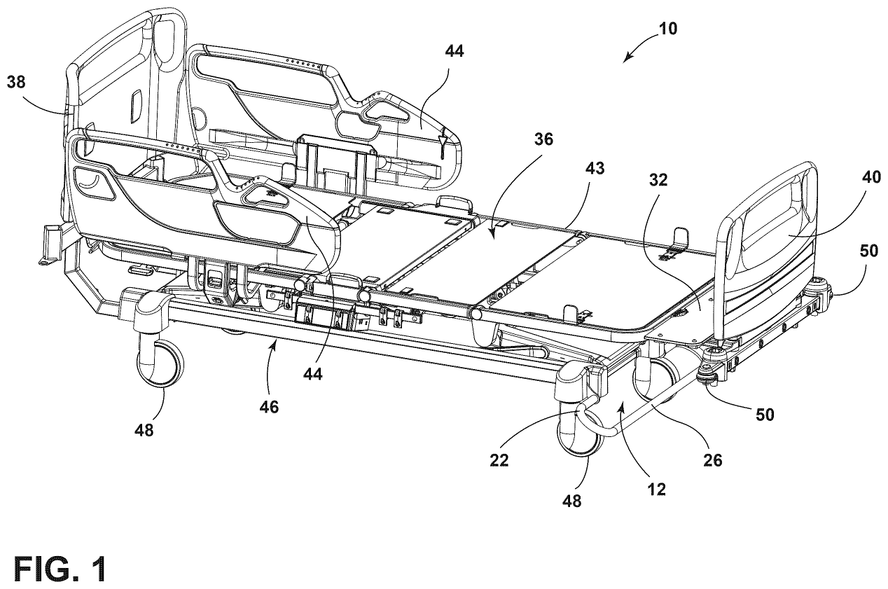

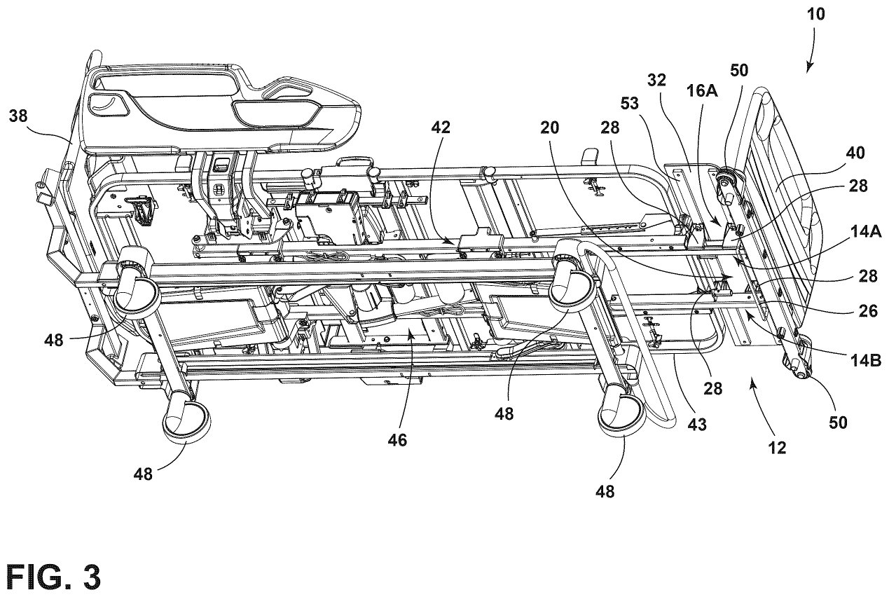

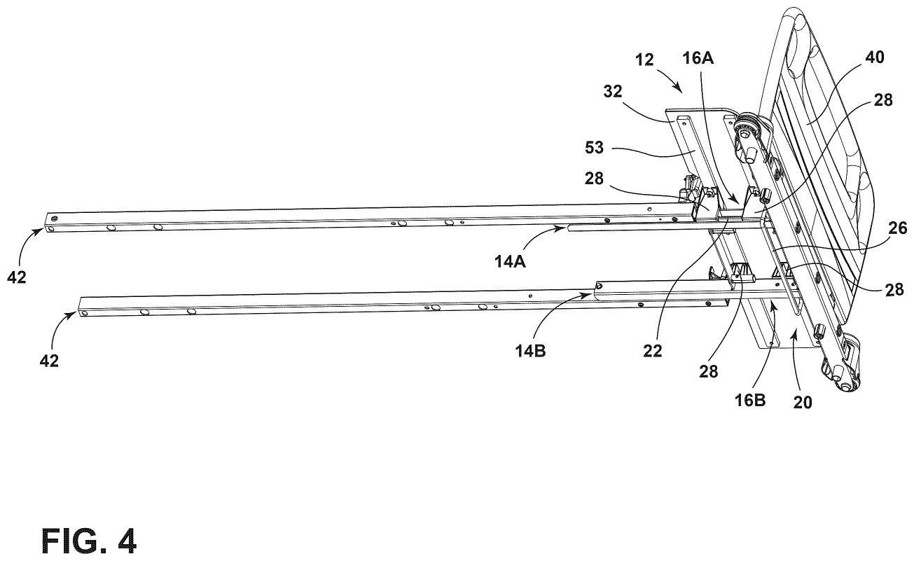

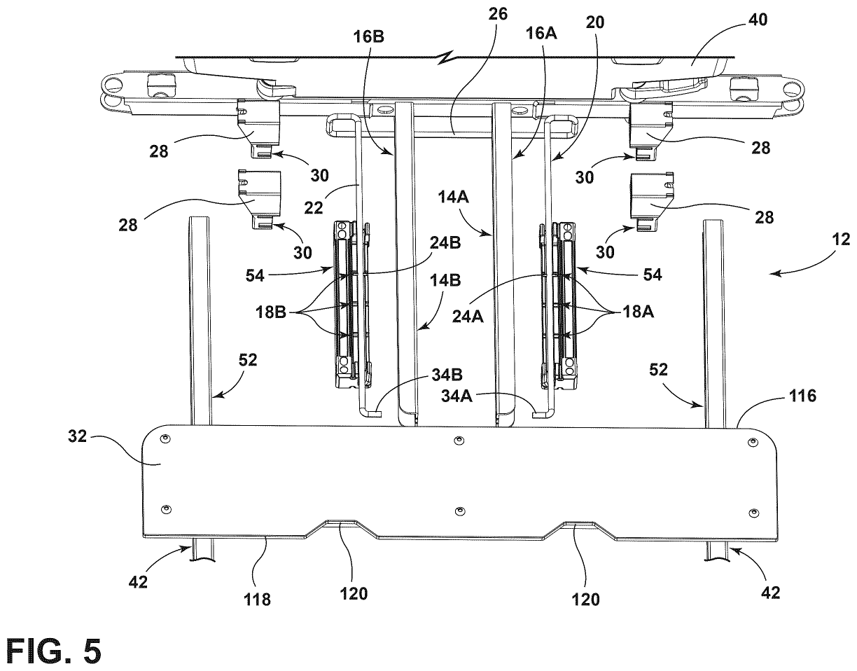

Referring initially to FIGS. 1-5, reference numeral 10 generally designates a patient bed that includes an extension accessory 12. The extension accessory 12 includes a first moveable beam 14A and a second moveable beam 14B both configured to be attached to the patient bed 10 and moveable between a stowed position and an extended position. The first moveable beam 14A defines a first longitudinal groove 16A and includes at least one first pocket 18A. An actuating assembly 20 includes an actuating body 22 (e.g., a wire frame) extending through the first longitudinal groove 16A between a first locking body 24A and a lever 26 (e.g., a handle). The actuating body 22 is moveable (e.g., flexible) between a locked position where the first locking body 24A is located in the at least one first pocket 18A to secure the first moveable beam 14A from movement, and an unlocked position where the actuating body 22 is configured to be moved by (e.g., deformed through) engagement with the lever 26 and the first locking body 24A is located outside of the at one first pocket 18A, permitting movement of the first moveable beam 14A (FIG. 5). At least one connection block 28 includes an engagement profile 30 that is sized to be inserted into the first longitudinal groove 16A and prevent movement (e.g., deformation) of the actuating body 22 (FIG. 5). An extension plate 32 is connectable to the at least one connection block 28.

With continued reference to FIGS. 1-5, the second moveable beam 14B may, likewise, define a second longitudinal groove 16B and at least one second pocket 18B. The actuating body 22 may, therefore, include a second locking body 24B spaced on an opposite side of the lever 26 than the first locking body 24A. The second locking body 24B is moveable between the unlocked and locked positions through engagement with the lever 26 (e.g., via a patient's hand, foot, etc.). In this manner, the first and second moveable beams 14A, 14B may moveable linearly with respect to an axis A between the stowed position and the extended position. The lever 26 may be defined by a downward bend in the actuating body 22. The actuating body 22 may include a first pivot boot 34A pivotally connected to an aperture defined by the first moveable beam 14A and located on a side of the first locking body 24A opposite the lever 26. The actuating body 22 may further include a second pivot boot 34B pivotally connected to an aperture defined by the second moveable beam 14B and located on a side of the second locking body 24B opposite the lever 26. The first pivot boot 34A and the second pivot boot 34B may be formed by a bend in the actuating body 22. In this manner, the actuating body 22 may be formed of a wire body (e.g., a singular wire body) and the first and second locking bodies 24A, 24B are attached to the wire body. The actuating body 22 may be formed of a material with elastic memory (e.g., spring steel), permitting repeated deformations between the locked and unlocked positions without substantial impact (e.g., permanent deformation) to the material.

In the depicted implementations in FIGS. 1-4, the patient bed 10 may include patient support surface 36 extending between a headboard 38 (e.g., first end) and a footboard 40 (e.g., second end) spaced by a pair of side surfaces 43, which may each include one or more side boards 44. While the extension accessory 12 is depicted as elongating the patient support surface 36 along the axis A from the footboard 40, it should be appreciated that the extension accessory 12 may also be utilized for elongating the patient support surface 36 along the axis A from the headboard 38, and/or perpendicular to the axis A from one or both of the side surface 43 for widening the patient support surface 36. In other words, the extension accessory 12 may be utilized for extending a length (e.g., between the headboard 38 and the footboard 40) of the patient support surface 36 or a width (e.g., between side surfaces 43) of the patient support surface 36 based on patient size, shape, and scenario. In implementations where the width is widened, the first moveable beam 14A, the second moveable beam 14B, and the actuating assembly 20 may be rotated 90° in either direction from those depicted. Likewise, in such implementations, the extension plate 32 may be sized to extend along only a portion or substantially all of the length. In implementations where the length is increased, the extension plate 32 may be sized to extend along only a portion or substantially all of the width. It is further contemplated that, in some implementations, the patient bed 10 may be configured to both increase in width and length. As such, the depicted arrangement is provided as an example only and other implementations may utilize multiple of the same components described throughout and/or the same components described throughout in different orientations for increasing width or length.

The patient bed 10 may include a base frame 46 connected to one or more wheels 48 (e.g., caster wheels) to facilitate moving the patient bed 10 around a medical environment. Deflection wheels 50 may be located proximate the headboard 38 (e.g., first end) and/or the footboard 40 (e.g., second end) for deflecting the patient bed 10 from walls, objects, and other vertical surfaces within the medical environment. While some components are described herein in pairs, such as the first moveable beam 14A, the second moveable beam 14B, it is contemplated that a single moveable beam may be utilized for a simpler architecture. For example, a single moveable beam may be substantially central between the side surfaces 43 in implementations that increase the length or substantially central between the headboard 38 and the footboard 40 in implementations that increase the width. Likewise, while components some components are described herein in pairs, such as the first moveable beam 14A, the second moveable beam 14B, it is contemplated that more than two of these components can be utilized for a stronger architecture.

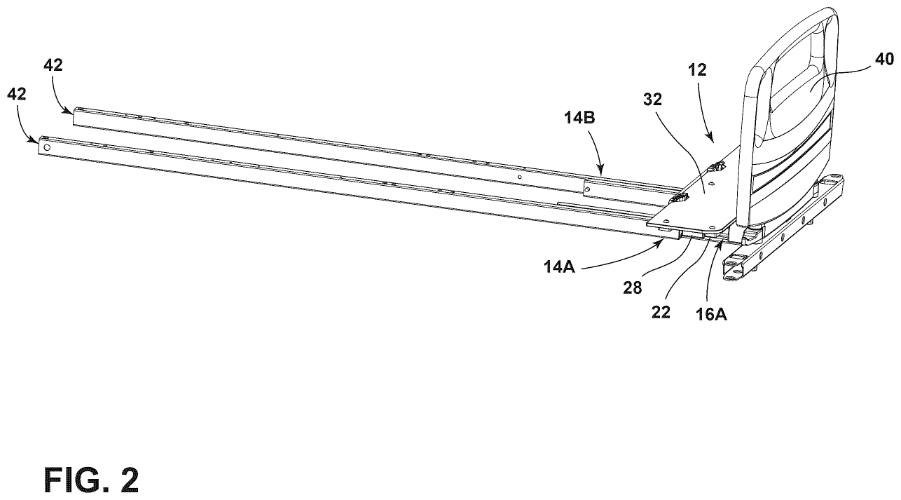

As best depicted in FIGS. 2-4, the patient bed 10 may include a pair of stationary beams 42 that are located under and coupled to the patient support surface 36. The moveable beams 14A, 14B may each be moveably coupled to one of the pair of stationary beams 42 and moveable between the stowed position and the extended position (e.g., linearly). In this manner, the moveable beams 14A, 14B move relative to the stationary beams 42 via the actuating assembly 20. The relative movement between the stationary beams 42 and the moveable beams 14A, 14B may be telescopic, via an interlocked rack and pinion gear arrangement, slidable with various bearing arrangements, or via other methodologies and structures. In the depicted implementation, the pair of stationary beams 42 may each define an opposing longitudinal groove 52 facing the longitudinal grooves 16A, 16B, respectively. The stationary beams 42 may be coupled to the patient support surface 36 via brackets, welds, fasteners, and/or the like.

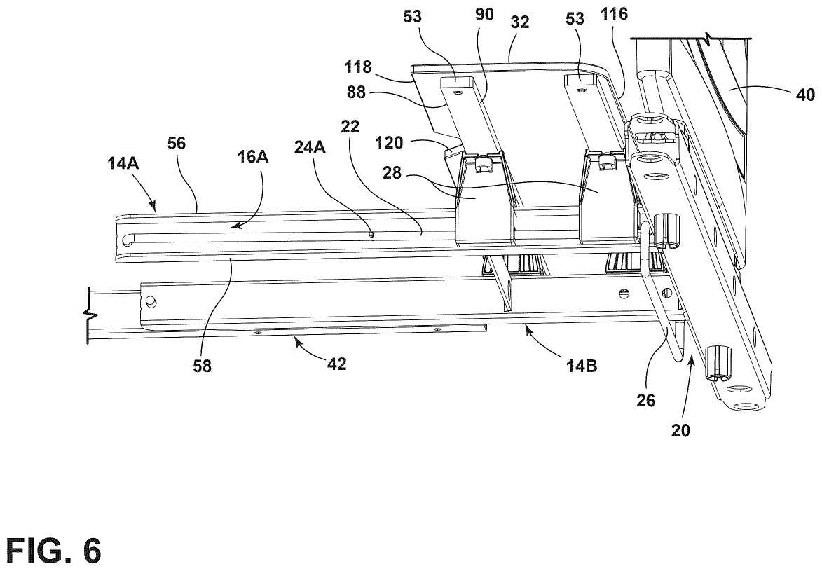

Referring now to FIGS. 5-8, the moveable beams 14A, 14B may each include an insert 54 that is located in and extends between one of the opposing longitudinal grooves 52 and one of the longitudinal grooves 16A, 16B facilitating and guiding slidable movement between the stationary beams 42 and the moveable beams 14A, 14B. The inserts 54 may define that at least one first and second pockets 18A, 18B. In some embodiments, the at least one first pocket 18A includes a plurality of first pockets 18A in a series, and the at least one second pocket 18B includes a plurality of second pockets 18B in a series that may be aligned with one another to provide multiple locked positions. In this manner, the extension plate 32 may include a variety of sizes associated with the multiple locked positions for providing extension surfaces to the patient bed 10 based on patient need and scenario. As best depicted in FIG. 6, the extension plate 32 may include at least one supporting cross-member 53 that extends at least across the moveable beams 14A, 14B. In some embodiments, the at least one supporting cross-member 53 may include a plurality of supporting cross-members 53 (e.g., two, three, or more). Each of the supporting cross-members 53 may be connected to the extension plate 32 via fasteners, adhesives, clamps, combinations thereof, and/or the like. In operation, the supporting cross-members 53 may provide rigidity and support to the extension plate 32 and also facilitate connection to the at least one connection block 28.

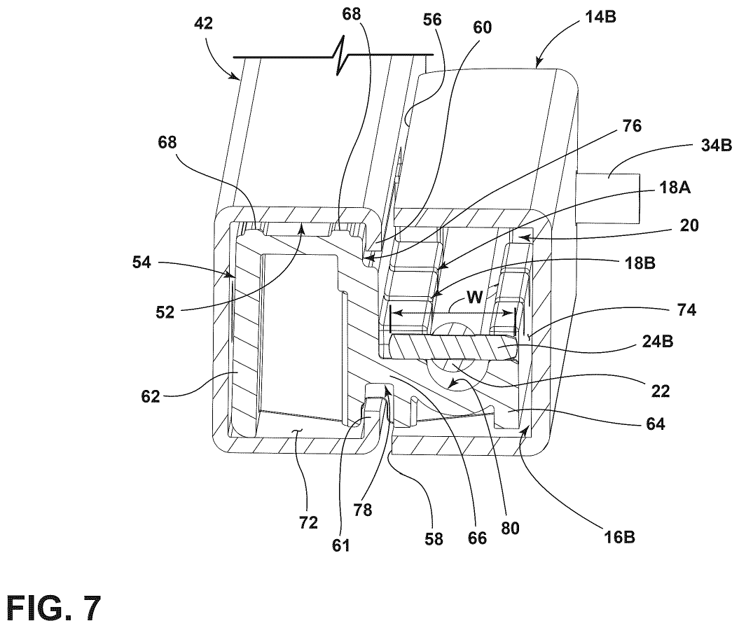

In some embodiments, the extension accessory 12 may include two or more extension plates 32 of various sizes associated with the multiple locked positions for providing different levels of extension (e.g., in length or width). As best depicted in FIG. 7, the longitudinal grooves 16A, 16B of the moveable beams 14A, 14B may be bounded by an upper edge 56 and a lower edge 58. In some embodiments, the moveable beams 14A, 14B may be generally defined as having a C-shape cross-section (e.g., a metal extrusion with a C-shaped cross-section). Similarly, the opposing longitudinal grooves 52 of the stationary beams 42 may include an upper stationary edge 60 and a lower stationary edge 61. In some embodiments, the stationary beams 42 may be generally defined as having a C-shape cross-section (e.g., a metal extrusion with a C-shaped cross-section). The upper stationary edge 60 may be defined by a downward bend and extend towards the opposing longitudinal groove 52 and the lower stationary edge 61 may be defined by an upward bend and extend towards the opposing longitudinal groove 52. In some embodiments, the moveable beams 14A, 14B and the stationary beams 42 may substantially have the same dimensions cross-sectionally. In some implementations, at least a top surface of the moveable beams 14A, 14B and the stationary beams 42 are substantially planar. In some embodiments, the moveable beams 14A, 14B may extend along the axis A and the stationary beams 42 may extend along the axis A a greater distance than the moveable beams 14A, 14B.

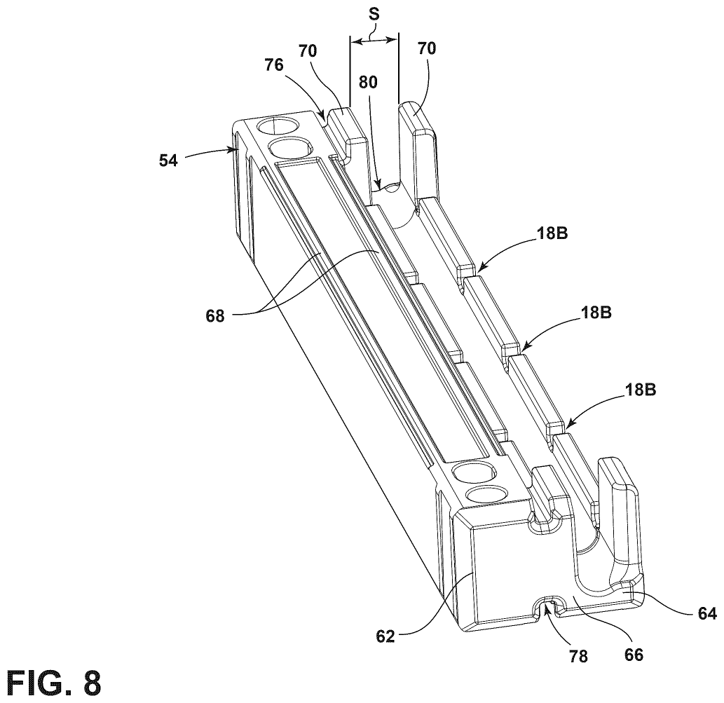

With reference now to FIGS. 7 and 8, the insert 54 may include a first portion 62 located in the stationary beam 42 (e.g., the opposing longitudinal grooves 52) and a second portion 64 located in the associated longitudinal groove 16A, 16B of the moveable beam 14A, 14B. In the depicted embodiment, the first portion 62 of the insert 54 may be statically connected to the stationary beam 42 and the second portion 64 may be moveable relative to the moveable beam 14A, 14B within the longitudinal groove 16A, 16B. More particularly, the first portion 62 of the insert 54 may be statically connected to the stationary beam 42 via one or more fasteners, brackets, adhesives, welds, interference fit, and/or the like.

In some implementations, the first portion 62 of the insert 54 may be slidably connected to stationary beam 42 and the second portion 64 of the insert 54 may be statically connected to moveable beam 14A, 14B via one or more fasteners, brackets, adhesives, welds, interference fit, and/or the like. Alternatively, in some embodiments, the first portion 62 of the insert 54 may be moveable relative to the stationary beam 42 and the second portion 64 may be moveable relative to the moveable beam 14A, 14B. In such embodiments, movement limiters (not shown) may be located in the stationary beam 42 and the moveable beam 14A, 14B. More particularly, the movement limiters may provide hard stops between the stationary beam 42 and the moveable beam 14A, 14B between the stowed position and the extended position. For example, the movement limiters may include posts, dimples, ribs, and/or the like extending into (e.g., integral with or coupled thereto) the longitudinal groove 16A, 16B and the opposing longitudinal groove 52 on opposite sides of the insert 54. However, the movement limiters may include other types of structures, such as brackets, projections, combinations thereof, and/or the like. When the first portion 62 of the insert 54 is moveable relative to the stationary beam 42 and the second portion 64 of the insert 54 is moveable relative to the moveable beam 14A, 14B, the stationary beam 42 and/or first portion 62 of the insert 54 may define the pockets 18A, 18B. It should also be appreciated that, while the moveable beams 14A, 14B are depicted as being located inwardly (e.g., between the stationary beams 42), in some embodiments, the stationary beams 42 may be located inwardly relative to the moveable beams 14A, 14B and function under the same operational principles as described above but with a reverse orientation. Regardless of the orientation of the stationary beams 42 and the moveable beams 14A, 14B, the longitudinal grooves 16A, 16B may generally face their respective opposing longitudinal groove 52 that, together from channels for the insert 54.

Referring still to FIGS. 7 and 8, the first portion 62 of the insert 54 may connect to the second portion 64 via a bridge portion 66. The first portion 62 may define at least one first portion rail 68 (e.g., a pair of first portion rails 68 that may extend substantially parallel to one another) and the second portion 64 may define at least one second portion rail 70 (e.g., a pair of second portion rails 70 that may extend substantially parallel to one another). The first portion rails 68 and the second portion rails 70 may extend from a top surface of the insert 54 and interface with an interior surface 74 of the stationary beams 42 and an interior surface 74 of the moveable beam 14A, 14B, respectively. An upper groove 76 may be defined by a top surface of the insert 54. For example, the upper groove 76 may be located between one of the second portion rails 70 and the first portion rails 72. The upper groove 76 may accommodate the upper stationary edge 60 and facilitate relative securement and slidable movement between the stationary beams 42 and the moveable beam 14A, 14B. A lower groove 78 may be defined by a bottom surface of the insert 54. For example, the lower groove 78 may be aligned with the upper groove 76. The lower groove 78 may accommodate the lower stationary edge 61 and also facilitates relative securement and slidable movement between the stationary beams 42 and the moveable beam 14A, 14B.

Each of the second portion rails 70 may be defined by two rail members spaced by the pockets 18A, 18B. The pockets 18A, 18B may each include one, two, three, four, or more pockets for setting the range of extension. The rail members of one of the second portion rails 70 may be spaced by the rail members of another of the second portion rails 70 a space S that is less than a width “W” of the first and second locking bodies 24A, 24B (FIGS. 7 and 8). In this manner, the space S between the second portion rails 70 limits the travel path of the first and second locking bodies 24A, 24B of the actuator 20. The second portion 64 of the insert 54 may define a wire channel 80 extending along a length of the second portion 64. The wire channel 80 may be sized to accommodate and guide the actuating body 22 therein. The actuating body 22 may be formed of a metal material with elastic memory, such as spring steel. The actuating body 22 may define a circular cross-section defining a gauge. For example, the gauge of the actuating body 22 may be between about 5 mm and about 10 mm in diameter, for example, about 8 mm in diameter. The wire channel 80 may likewise define a partial circumference that seats the actuating body 22. In some implementations, the pockets 18A, 18B may also define a partial circumference that seats the first and second locking bodies 24A, 24B.

In some embodiments, the insert 54 may be formed of a plastic material, the stationary beam 42 may be formed of a metal material, and the moveable beam 14A, 14B may be formed of the metal material. For example, the stationary beam 42 and the moveable beam 14A, 14B may, for example, be formed via an extrusion process (e.g., of aluminum) and/or the insert 54 may be integrally formed (e.g., molded). A lubricant may be located between the first portion 62 and the stationary beam 42 and the second portion 64 and the moveable beam 14A, 14B. Alternatively, bearings (e.g., spherical members) may be located between the first portion 62 and the stationary beam 42 and the second portion 64 and the moveable beam 14A, 14B.

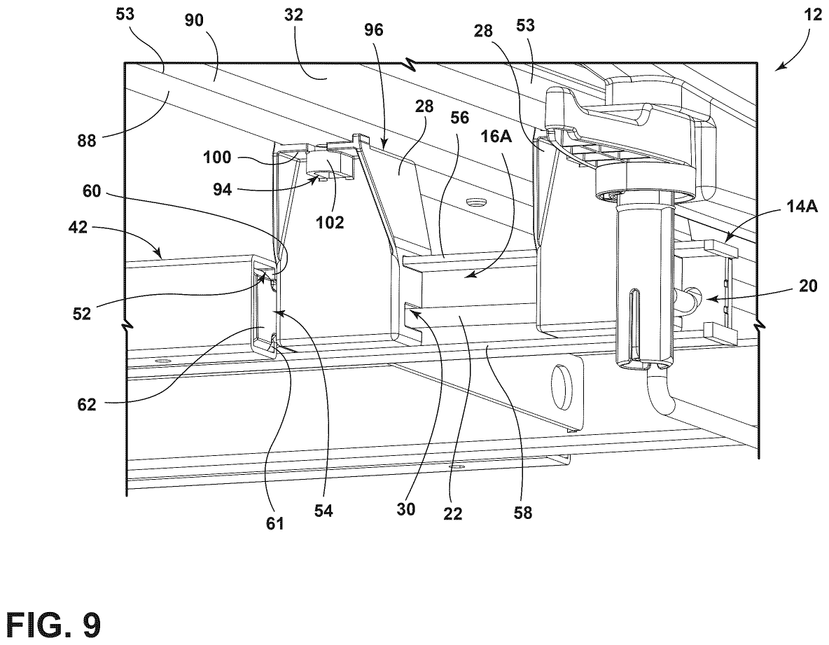

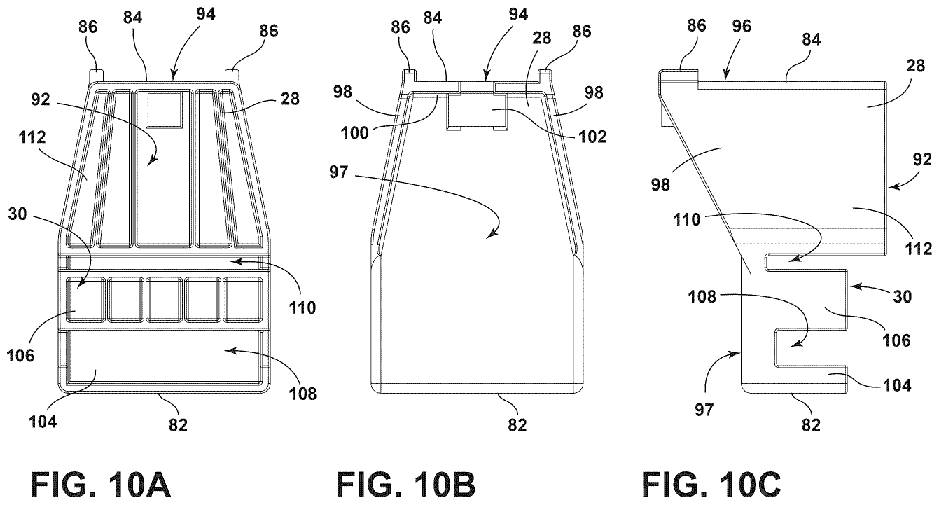

With reference now to FIGS. 9-10C, the at least one connection block 28 may include a plurality of connection blocks 28. Each connection block 28 may extend from a bottom block surface 82 to a top block surface 84. The top block surface 84 may define a pair of ridges 86 sized to locate the supporting cross-members 53. More particularly, the supporting cross-members 53 may define a supporting bottom surface 88 and a pair of supporting side surfaces 90. In some implementations, the cross-members 53 are rectilinear. The top block surface 84 contacts the supporting bottom surface 88 and may be the same as (e.g., flat) or an inverted shape from (e.g., concave or convex) the supporting bottom surface 88. The ridges 86 contact the supporting side surfaces 90 and, likewise, may be the same as (e.g., flat) or an inverted shape from (e.g., concave or convex) the supporting side surfaces 90. In this manner, the top block surface 84 and ridges 86 overlay the associated supporting cross-members 53 to secure the extension plate 32 to the moveable beam 14A, 14B.

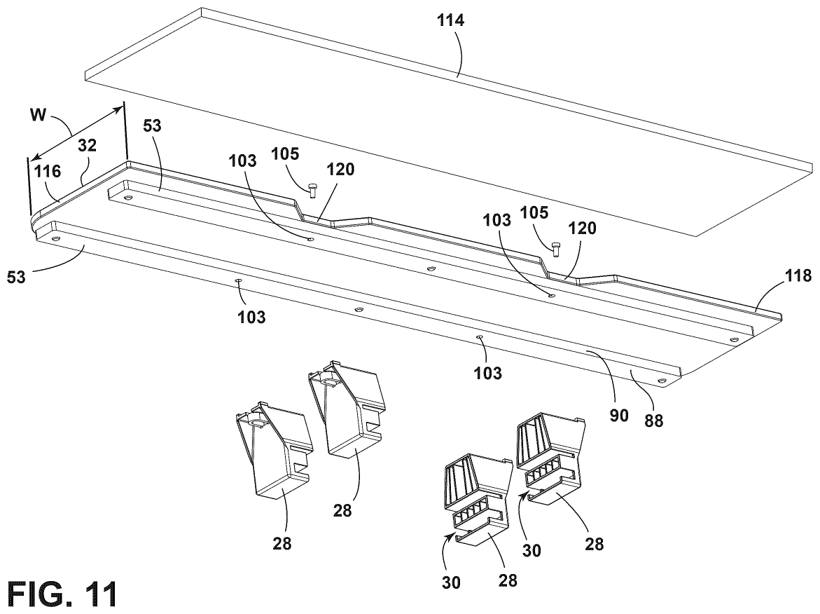

With continued reference to FIGS. 9-10C, the engagement profile 30 may be proximate to the bottom block surface 82 such that the top block surface 84 extends above the first moveable beam 14A and the top block surface 84 and ridges 86 support the extension plate 32. In this manner, the top block surface 84 may extend above the first moveable beam 14A a distance that permits a top surface of the extension plate 32 or an added mattress accessory 114 thereof (FIG. 11) to be substantially co-planar or flush with the patient support surface 36. The engagement profile 30 may be defined by a front connection block surface 92 as depicted in FIG. 10A. The front connection block surface 92 faces an associated one of the moveable beams 14A, 14B. The top block surface 84 may define an opening 94 configured to receive a bolt through the extension plate 32 and secure the extension plate 32 (e.g., the cross-member 53) to the connection block 28. In some implementations, the opening 94 may be threaded and engage with threads of the bolt. In some implementations, an end of a shaft of the bold clamps onto the cross-member 53 for an interference fit. In some implementations, the cross-member includes another aperture (e.g., threaded) that is alignable with the opening 94 for engagement (e.g., threaded) with the bolt. A bushing or other bearing element may be embedded in one of the top block surface 84 and/or the cross-member 53. In some implementations, the bushing is formed of stronger material (e.g., metal, steel, brass, etc.) than the top block surface 84 and/or the cross-member 53.

The top block surface 84 includes a cantilevered portion 96 extending from a rear connection block surface 97 (FIG. 10B) in a direction opposite the engagement profile 30. In this manner, the top block surface 84 may be wider than the bottom block surface 82. In some embodiments, the opening 94 may be defined by the cantilevered portion 96 and, more particularly, a portion of the cantilevered portion 96 that overhangs from the bottom block surface 82 to provide space for coupling the bolt. A pair of opposing supporting plates 98 may extend from the cantilevered portion 96 towards the bottom block surface 82 and connect to the rear connection block surface 97. The supporting plates 98 may add rigidity and support to the connection block 28.

A bottom surface 100 of the cantilevered portion 96 may define a bushing projection 102 at least partially defining the opening 94 and extending towards the bottom block surface 82. The bushing projection 102 may be formed or otherwise include the bushing insert or bearing element may be formed of metal that at least partially defines the opening 94. The opening 94 may include internal threads defined by the top block surface 84, the bushing projection 102, and/or the bushing insert. Generally speaking, the connection block 28 may be integrally formed (e.g., molded), other than the optional bushing insert. In some implementations, the connection block 28 may be formed of a plastic material (e.g., the same plastic material as the insert 54). The extension plate 32 may include apertures 103 that align with the openings 94 of the connection blocks 28 (e.g., one or more apertures 103 for each connection block 28). Each aperture 103 may define internal threads matched with the openings 94 for receiving fasteners 105 (e.g., bolts) that secure the extension plate 32 to the connection blocks 28. In some embodiments, the apertures 103 may be aligned with and extend through the supporting cross-members 53 for added securement. In some embodiments, an additional bushing insert may be located in (e.g., imbedded) in the cross-members 53 as described previously.

Still referring to FIGS. 10A-10C, the engagement profile 30 may define a first rib 104 and a second rib 106 defining a wire recess 108 therebetween. The first rib 104 may be proximate (e.g., flush with) the bottom block surface 82 and the second rib 106 may be located between the first rib 104 and the top block surface 84. During use, the wire recess 108 is sized to accommodate the actuating body 22 and secure the actuating body 22 from flexing to the unlocked position. More particularly, the first rib 104 is inserted the longitudinal grooves 16A, 16B between the actuating body 22 and the lower edge 58 of the associated moveable beam 14A, 14B and the second rib 106 is inserted the longitudinal grooves 16A, 16B between the actuating body 22 and the upper edge 56 of the associated moveable beam 14A, 14B. A lower surface of the first rib 104 may contact the interior surface 74 proximate the lower edge 58 and an upper surface of the second rib 106 may contact the interior surface 74 proximate the upper edge 56.

The engagement profile 30 may define a beam recess 110 at least partially defined by the second rib 106 that is sized to accommodate the upper edge 56 of the moveable beam 14A, 14B. A body portion 112 in conjunction with opposing supporting plates 98 may partially define the beam recess 110. The body portion 112 extends from the front connection block surface 92 opposite the opposing supporting plates 98. The body portion 112 extends from and is in contact with a top surface of the moveable beam 14A, 14B to the top block surface 84 that is in contact with the extension plate 32 (e.g., the supporting cross-member 53). In this manner, the body portion 112 is essentially wedged between the moveable beam 14A, 14B and the extension plate 32 by the weight of the extension plate 32 and, if present, the patient. The engagement profile 30 secures the connection blocks 28 in an inward direction towards the moveable beam 14A, 14B. In some implementations, the body portion 112 overhangs from the first and second ribs 104, 106 on the front connection block surface 92 and opposite the cantilevered portion 96 to ease handling by a healthcare professional.

With reference now to FIG. 11, components of the extension accessory 12 are depicted in a disassembled state. The extension accessory 12 may include a mattress accessory 114 that can be placed on the extension plate 32 in conjunction with a primary mattress (not shown) to elongate the patient support surface 36 in a co-planar manner. The mattress accessory 114 may substantially match a contour (e.g., peripheral edge) of the extension plate 32. However, a medical environment may include multiple primary mattress sizes, thicknesses, and lengths that can be interchanged without necessitating the mattress accessory 114. Likewise, the mattress accessory 114 may include a plurality of mattresses of various sizes, thicknesses, and lengths that can be attached to the extension plate 32. The attachment between the mattress accessory 114 and the extension plate 32 may be permanent or selective by a coupling mechanism such as sewing, rivets, belt, buckles, buttons, snaps, hooks, adhesive, Velcro, or other secure attachment mechanism that allows the mattress accessory 114 to be removed for cleaning.

It should be appreciated that, in some embodiments, the extension accessory 12 may include moveable beams 14A, 14B, the actuating body 22, the connection blocks 28, the extension plate 32, the insert 54, the fasteners 105, and optionally the mattress accessory 114. However, in other embodiments, the extension accessory 12 may only include the connection blocks 28, the extension plate 32, the fasteners 105, and optionally the mattress accessory 114 depending on the architecture of the patient bed 10 (e.g., if the moveable beams 14A, 14B and the actuating body 22 or some other extension assembly are already integrated). Furthermore, components of the extension accessory 12, such as the extension plate 32 or a plurality of different sized extension plates 32, and one or more of the connection blocks 28 may be provided separately on an as-needed basis. Generally speaking, any singular component or combination of components described herein may be referred to as a “patient bed extension system” that exhibits some or all of the above described benefits of dynamically extending a patient support surface 36. Likewise, as described above various combinations of the components of the patient bed extension system may be used in different orientations for extending the patient support surface 36 in one or both directions along the length of the patient bed 10 and/or one or both directions along the width of the patient bed 10.

The extension plate 32 may have a width “W” defining the elongation of the patient support surface 36. The width W of the extension plate 32 (or a plurality of extension plates 32 individually) may be between about 8 cm and about 20 cm, for example, between about 10 cm and 18 cm, about 15 cm, and/or about 16 cm. In some implementations, different sized extension plates 32 may be used together (e.g., coupled to different connection blocks 28 to obtain a desired elongation). As depicted, the extension plate 32 may include a rear edge 116 facing the footboard 40 with curved corners to prevent damaging objects in the medical environment when the patient bed 10 is stationary or mobile. The extension plate 32 may further include and a front edge 118 with one or more depressions 120 for retrofitting around components of the patient bed 10.

The disclosure herein may be further summarized in the following paragraphs and further characterized by combinations of any and all of the various aspects described therein.

According to one aspect of the present disclosure, an extension accessory for a patient bed includes a first moveable beam and a second moveable beam both configured to be attached to the patient bed and moveable between a stowed position and an extended position. The first moveable beam defines a first longitudinal groove and includes at least one first pocket. An actuating assembly includes an actuating body extending through the first longitudinal groove between a first locking body and a lever. The actuating body is moveable between a locked position where the first locking body is located in the at least one first pocket to secure the first moveable beam from movement, and an unlocked position where the actuating body is configured to be moved by engagement with the lever and the first locking body is located outside of the at least one first pocket, permitting movement of the first moveable beam. At least one connection block includes an engagement profile that is sized to be inserted into the first longitudinal groove and prevent movement of the actuating body. An extension plate is connectable to the at least one connection block.

According to another aspect, a second moveable beam defines a second longitudinal groove and at least one second pocket and an actuating body includes a second locking body spaced on an opposite side of a lever than a first locking body, the second locking body moveable between unlocked and locked positions through engagement with the lever.

According to still another aspect, the first and second moveable beams are moveable linearly with respect to an axis.

According to yet another aspect, a lever of an actuating assembly is defined by a downward bend in an actuating body.

According to another aspect, an actuating body includes a first pivot boot pivotally connected to an aperture defined by a first moveable beam, the first pivot boot located on a side of a first locking body opposite a lever.

According to still yet another aspect, the first pivot boot is formed with a bend in an actuating body.

According to yet another aspect, at least one first pocket includes a plurality of first pockets in series providing multiple locked positions.

According to another aspect, at least one first pocket includes a plurality of first pockets in series and at least one second pocket includes a plurality of second pockets in series providing multiple locked positions.

According to still another aspect, an actuating body is formed of a singular wire body and first and second locking bodies attached to the singular wire body.

According to yet another aspect, a first moveable beam includes an insert located in a first longitudinal groove of the first moveable beam and defines at least one first pocket.

According to another aspect, at least one connection block extends from a bottom block surface to a top block surface and includes an engagement profile that is proximate the bottom block surface such that the top block surface extends above a first moveable beam and the top block surface supports an extension plate.

According to still another aspect, at least one connection block extends from a bottom block surface to a top block surface, the top block surface defining an opening configured to receive a bolt through an extension plate and secure the extension plate to the at least one connection block.

According to still yet another aspect, an engagement profile of at least one connection block includes a first rib and a second rib defining a wire recess therebetween. A wire recess is sized to accommodate an actuating body and secure the actuating body from flexing to an unlocked position.

According to another aspect, an engagement profile defines a beam recess that is sized to accommodate an upper edge of the first moveable beam that bounds a first longitudinal groove.

According to still another aspect, a first rib and a second rib are insertable into a first longitudinal groove. The first rib contacting an interior surface of an upper edge and the second rib contacting an interior surface of a lower edge that, together, bound the first longitudinal groove of first moveable beam.

According to another aspect of the present disclosure, an extension accessory for a patient bed includes an extension plate that has a peripheral edge defining a top surface for supporting a patient and a bottom surface with a plurality of holes extending through the top and bottom surfaces. A plurality of connection blocks each includes a top block surface spaced from a bottom block surface. An engagement profile is between the top block surface and the bottom block surface that is sized to be coupled to a moveable beam. An opening extends through the top block surface, and a plurality of fastening members are each configured to be inserted through one of the holes of the extension plate and the opening of one of the plurality of connection blocks.

According to another aspect, a top block surface includes a cantilevered portion extending in a direction opposite an engagement profile and an opening is defined by the cantilevered portion.

According to still another aspect, opposing supporting plates extend from a cantilevered portion towards a bottom block surface.

According to still yet another aspect, a bottom surface of a cantilevered portion defines a bushing projection at least partially defining an opening and extending towards a bottom block surface.

According to another aspect, an engagement profile is proximate a bottom block surface such that a top block surface is positioned to support the extension plate.

According to still another aspect, an engagement profile includes a first rib and a second rib defining a wire recess therebetween, the wire recess sized to accommodate an actuating body and secure the actuating body from flexing to an unlocked position.

According to another aspect, an engagement profile defines a beam recess sized to accommodate an upper edge of a first moveable beam coupled to a patient bed.

According to still another aspect, a mattress accessory is sized to be supported by a top surface of an extension plate.

According to yet another aspect of the present disclosure, a patient bed includes a patient support surface extending between a headboard and a footboard. A pair of stationary beams are located under and coupled to the patient support surface. A pair of moveable beams are each moveably coupled to one of the pair of stationary beams and moveable between a stowed position and an extended position. The pair of moveable beams each define a longitudinal groove and at least one pocket. An actuating assembly includes an actuating body extending through the longitudinal grooves between a pair of locking bodies spaced by a lever. The actuating body is moveable between a locked position where the locking bodies are located in the at least one pockets, to secure the pair of moveable beams from movement, and an unlocked position where the actuating body is configured to be moved by engagement of the lever and the locking bodies are located outside of the at least one pockets, permitting movement of the pair of moveable beams relative to the stationary beams. An extension plate is selectively coupled to the moveable beams.

According to another aspect, a pair of stationary beams defines an opposing longitudinal groove facing a longitudinal groove of a moveable beam, respectively.

According to still another aspect, a pair of inserts, each insert located in and extending between one of an opposing longitudinal groove and a longitudinal groove facing the opposing longitudinal groove, facilitating and guiding slidable movement between the stationary beams and the moveable beams.

According to still yet another aspect, each of a pair of inserts defines a pocket.

According to another aspect, each insert defines a plurality of pockets in series providing multiple locked positions.

According to still another aspect, each of a pair of inserts defines rails interfacing with the interior surfaces of stationary beams and moveable beams.

According to another aspect, each of a pair of inserts includes a portion located in a longitudinal groove that defines a channel for accommodating an actuating body.

According to still yet another aspect of the present disclosure, a connection block of an extension accessory for a patient bed includes a top block surface defining an opening for receiving a fastener. A bottom block surface is spaced from the opening. An engagement profile is located between the top block surface and the bottom block surface that includes a beam recess sized to insert an upper edge of a moveable beam.

According to another aspect, a connection block includes a first rib and a second rib. A beam recess is defined between the second rib and a body portion extending to the top block surface.

According to yet another aspect, a wire recess is defined between a first rib and a second rib. The wire recess is sized to accommodate an actuating body and secure the actuating body in a locked position.

According to still another aspect, a connection block includes a top block surface. The top block surface defines a pair of ridges sized to accommodate a supporting cross-member of an extension plate.

According to another aspect, a connection block includes a top block surface. The top block surfaces include a cantilevered portion extending in a direction opposite an engagement profile and an opening is defined by the cantilevered portion.

According to yet another aspect, a connection block defines an opening and the opening is further defined by a bushing projection that extends towards the bottom block surface.

According to still another aspect, a bushing projection includes a bushing insert formed of a metal material.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An extension accessory for a patient bed, the extension accessory comprising:
a first moveable beam and a second moveable beam both configured to be attached to said patient bed and moveable between a stowed position and an extended position, the first moveable beam defining a first longitudinal groove and including at least one first pocket;
an actuating assembly that includes an actuating body extending through the first longitudinal groove between a first locking body and a lever, the actuating body being moveable between a locked position wherein the first locking body is located in the at least one first pocket to secure the first moveable beam from movement, and an unlocked position wherein the actuating body is configured to be moved by engagement with the lever and the first locking body is located outside of the at least one first pocket thereby permitting movement of the first moveable beam;
at least one connection block having an engagement profile that is sized to be inserted into the first longitudinal groove and prevent movement of the actuating body; and
an extension plate connectable to the at least one connection block.

2. The extension accessory according to claim 1, wherein the second moveable beam defines a second longitudinal groove and at least one second pocket and the actuating body includes a second locking body spaced on an opposite side of the lever than the first locking body, the second locking body moveable between the unlocked and locked positions through engagement with the lever.

3. The extension accessory according to claim 2, wherein the at least one first pocket includes a plurality of first pockets in series and the at least one second pocket includes a plurality of second pockets in series providing multiple locked positions.

4. The extension accessory according to claim 2, wherein the actuating body is formed of a singular wire body and the first and second locking bodies are attached to the singular wire body, and the actuating body is moveable, at least in part, by deformation.

5. The extension accessory according to claim 1, wherein the first and second moveable beams are moveable linearly with respect to an axis.

6. The extension accessory according to claim 1, wherein the lever is defined by a downward bend in the actuating body.

7. The extension accessory according to claim 1, wherein the actuating body further includes a first pivot boot pivotally connected to an aperture defined by the first moveable beam, the first pivot boot located on a side of the first locking body opposite the lever.

8. The extension accessory according to claim 7, wherein the first pivot boot is formed with a bend of the actuating body.

9. The extension accessory according to claim 1, wherein the at least one first pocket includes a plurality of first pockets in series providing multiple locked positions.

10. The extension accessory according to claim 1, wherein the first moveable beam includes an insert located in the first longitudinal groove and defining the at least one first pocket.

11. The extension accessory according to claim 1, wherein the at least one connection block extends from a bottom block surface to a top block surface and the engagement profile is proximate the bottom block surface such that the top block surface extends above the first moveable beam and the top block surface supports the extension plate.

12. The extension accessory according to claim 1, wherein the at least one connection block extends from a bottom block surface to a top block surface, the top block surface defining an opening configured to receive a bolt through the extension plate and secure the extension plate to the at least one connection block.

13. The extension accessory according to claim 1, wherein the engagement profile of the at least one connection block includes a first rib and a second rib defining a wire recess therebetween, the wire recess sized to accommodate the actuating body and secure the actuating body from moving to the unlocked position.

14. The extension accessory according to claim 13, wherein the engagement profile further defines a beam recess sized to accommodate an upper edge of the first moveable beam bounding the first longitudinal groove.

15. The extension accessory according to claim 14, wherein the first rib and the second rib are insertable into the first longitudinal groove, the first rib contacting an interior surface of the upper edge and the second rib contacting an interior surface of a lower edge that also bounds the first longitudinal groove.

16. An extension accessory for a patient bed, the extension accessory comprising:
an extension plate including a peripheral edge defining a top surface for supporting a patient and a bottom surface with a plurality of holes extending through the top and bottom surfaces;
a plurality of connection blocks, each connection block comprising:
a top block surface spaced from a bottom block surface;
an engagement profile between the top block surface and the bottom block surface that is sized to be coupled to a moveable beam;
an opening extending through the top block surface; and
a plurality of fastening members each configured to be inserted through one of the holes of the extension plate and the opening of one of the plurality of connection blocks.

17. The extension accessory according to claim 16, wherein the engagement profile includes a first rib and a second rib defining a wire recess therebetween, the wire recess sized to accommodate an actuating body and secure the actuating body from moving to an unlocked position.

18. A patient bed comprising:
a patient support surface extending between a headboard and a footboard;
a pair of stationary beams located under and coupled to the patient support surface;
a pair of moveable beams, each moveable beam moveably coupled to one of the pair of stationary beams and moveable between a stowed position and an extended position, the pair of moveable beams each defining a longitudinal groove and at least one pocket;
an actuating assembly that includes an actuating body extending through the longitudinal grooves between a pair of locking bodies spaced by a lever, the actuating body being moveable between a locked position wherein the locking bodies are located the at least one pockets to secure the pair of moveable beams from movement, and an unlocked position wherein the actuating body is configured to be moved by engagement of the lever and the locking bodies are located outside of the at least one pockets, permitting movement of the pair of moveable beams relative to the stationary beams; and
an extension plate selectively coupled to the moveable beams.

19. The patient bed according to claim 18, wherein the pair of stationary beams defines an opposing longitudinal groove facing the longitudinal grooves, respectively.

20. The patient bed according to claim 19, further including a pair of inserts, each insert located in and extending between one of the opposing longitudinal groove and the longitudinal groove facilitating and guiding slidable movement between the stationary beams and the moveable beams.
